(19) United States
(12) Patent Application Publication
(10) Pub. No.: US 2025/0267113 A1
(43) Pub. Date: Aug. 21, 2025

(54) SYSTEMS AND METHODS FOR ADAPTER-BASED UNIVERSAL MESSAGE BROKERING IMPLEMENTING ARTIFICIAL INTELLIGENCE

(71) Applicant: BANK OF AMERICA CORPORATION, Charlotte, NC (US)

(72) Inventors: Rajesh Natarajan, Chennai (IN); Vimal Chandroliya, Gandhinagar (IN); Dhivya Dk, Chennai (IN); Preethi Jagadeesan, Chennai (IN); Magaranth Jayasingh, Chennai (IN)

(73) Assignee: BANK OF AMERICA CORPORATION, Charlotte, NC (US)

(21) Appl. No.: 18/581,712

(22) Filed: Feb. 20, 2024

(51) Int. Cl. H04L 51/066; H04L 69/22

(52) U.S. Cl. CPC H04L 51/066; H04L 69/22

(57) ABSTRACT

Universal message brokering is provided across known and future known computing platforms/systems. Message brokering occurs within adapters that are deployed directly within the computing platforms/systems. The adapters rely on Artificial Intelligence (AI) including Machine Learning (ML) to (i) identify the source and the target computing platforms/systems and (ii) convert/translate the messages from the source message format of the source computing platform/system to an identified universal message format and, upon receipt by the target computing platform/system, from the universal message format to the target message format. Further, the UMB adapters may additionally implement AI including ML to predict the volume of further message traffic and, in response, adjust message queues and/or UMB adapter activation in servers of distributed computing platforms/servers.

### FIELD OF THE INVENTION

The present invention is related generally to message brokering and, more specifically, and implementing Artificial Intelligence (AI), including Machine Learning (ML) to facilitate message communication between disparate communication platforms in which the messages have different formatting and/or protocols.

### BACKGROUND

Message brokers are used to allow disparate computing platforms/systems to communicate regardless of message format and/or protocols. Traditional message brokers rely on additional hardware that is disposed between the two computing platform/systems requiring message brokering. Moreover, traditional message brokers are limited in that the logic embodied therein is specific to the messaging format and/or protocols of the two specific disparate computing platforms/systems. Such specificity is necessary to ensure that the messages are translated properly.

Therefore, a need exists to develop systems, computerized methods, computer program products and the like that will allow for message brokering to occur in a universal fashion (i.e., regardless of computing platform/system type). In this regard, a need exists to develop systems, methods and the like that do not rely on pre-configured logic suitable only for converting/translating messages to/from one specific format and/or protocol(s) to/from another specific format and/or protocol(s). As such, a need exists to develop systems, method and the like that are computing platform/system-agnostic. Moreover, a need exists to develop systems, methods and the like that eliminate the need for a special infrastructure including additional hardware or the like.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide for systems, methods, computer program products and the like that provide for universal message brokering across all known and future known computing platforms/systems. Specifically, message brokering occurs within adapters, so-called Universal Message Broker (UMB) adapters that are deployed directly within the computing platforms/systems, thus, eliminating the need for any special infrastructure/hardware to exist between disparate computing platforms/systems.

The adapters are configured to receive messages emanating from the computing platform/system that they are deployed within and implement Artificial Intelligence (AI) including Machine Learning (ML) to (i) identify the source (i.e., the platform/system that the adapter is deployed within) and the target computing platforms/systems (i.e., the platform/system where the message is designated for receipt) and (ii) convert/translate the messages from the first message format of the source computing platform/system to an identified universal message format. In specific embodiments of the invention, multiclass classifier ML algorithms that rely on data mapping are used to identify the source and target computing platforms/systems and auto regressive ML models are used to convert/translate the message format to/from the universal message format. In other specific embodiments, the universal message format that is implemented for a specific message brokering process may be identified/determined by AI including ML or may be identified/defined by a user.

Once converted/translated to the universal message format, the UMB adapter broadcasts the message to the target computing system, which has a UMB adapter deployed therein. The UMB adapter of the target computing system is configured to receive the message and implement corresponding AI including ML to convert/translate the universal message format to the first message format implemented in the target computing system.

In specific embodiments of the invention, the UMB adapters are further configured to implement AI including ML to predict the volume of future message traffic. In response to such predictions, the UMB adapters are configured to adjust (increase or decrease) (i) the messaging queue in monolithic computing platforms/systems or (ii) the activation of adapters installed in servers of distributed computing platforms/systems.

In further embodiments of the invention, a dashboard application is implemented that allows user to define the universal message format, tuning new or existing ML models, receive alerts when UMB adapters are activated within servers and/or no further server capacity is available for UMB adapter activation.

As such, the present invention provides for universal messaging brokering across all computing platforms/systems. Further, by using adapters that deployed directly within the computing systems, the present invention eliminates the need for additional architecture/hardware to be implemented between the disparate computing platforms/system.

A system for universal message brokering defines first embodiments of the invention. The system includes a first computing platform, such as known computing platforms, including, but not limited to, mainframe; Application Systems/400 (AS/400®) developed by International Business Systems (IBM) of Armonk, New York; LINUX®; and WINDOWS® developed by Microsoft Corporation of Redmond, Washington, and future computing platforms, such as, but not limited to, quantum-based computing platforms. Each of the computing platforms may have distinct messaging protocols and/or formats.

First computing platform includes a first memory and one or more first computing processor devices in communication with the memory. The first memory stores at least one instance of a Universal Message Broker (UMB) adapter. For example, in monolithic platforms, such as mainframe and AS/400® the UMB adapter is installed on the single computing device, (e.g., server, PC or the like), while in distributed computing platforms, such as LINUX® and WINDOWS® the UMB adapter may be installed on all of the nodes (e.g., servers) in a cluster or just the controlling node. The UMB adapter is executable by at least one of the one or first computing processor devices.

The UMB adapter is configured to, upon activation, receive a message in a first message format and, in response, implement first Artificial Intelligence (AI) including first Machine Learning (ML) to analyze the message to identify (i) the first computing platform (i.e., source platform) and (ii) a second computing platform to which the message is to be broadcasted (i.e., target platform). Further, UMB adapter is configured to implement second AI including second ML to convert the message from the first message format to a universal message format, and broadcast the message in the universal message format to the identified second computing

The system additionally includes a second computing platform, which characteristically is a computing platform different in type from the first computing platform (e.g., the first computing platform is mainframe and the second computing platform is WINDOWS®) or the like). Second computing platform includes a second memory and one or more second computing processor devices in communication with the memory. The second memory stores at least one second instance of the UMB adapter (i.e., the same UMB adapter installed within the first computing platform). The UMB adapter is executable by at least one of the one or more second computing processor devices and is configured to, upon activation, receive the message in the universal message format, and implement the second AI including the second ML to convert the message from the universal message format to a second message format applied by the second computing platform.

In specific embodiments of the system, the first instance(s) of the UMB adapter is configured to, upon activation, identify the universal message format based, at least, on compatibility with the first and second computing platforms. In related specific embodiments of the system, identifying the universal message format includes implement the second AI including the second ML to identity the universal message format. While in other related embodiments of the system, the first memory and the second memory further store a dashboard application that is executable by at the first and/or second computing processor device(s) and is configured to receive first user input(s) that identify/define the universal message format. In further related specific embodiments of the system, the dashboard application is further configured to receive second user input(s) that are configured to tune one or more ML models from amongst at least one of the first ML and the second ML.

In other specific embodiments of the system, the UMB adapter is further configured to, upon activation, implement third AI including third ML (e.g., linear regression models) to analyze current message traffic received by the UMB adapter and predict future message traffic at the UMB adapter. In related embodiments of the system, the UMB adapter is further configured to, in response to predicting the future message traffic at the UMB adapter, perform at least one of (i) adjusting a size of a message queue (in monolithic computing platforms) and (ii) activating or deactivating instances of the UMB adapters (within separate computing devices (e.g., servers) of a distributed computing platform). In related embodiments of the invention, which include the aforementioned dashboard application, the dashboard application is further configured to present, to the user, at least one of (a) first alerts that notify the user of at least one of (i) adjustment to the size of the message queue, and (ii) specific instances of the UMB adapters that have been activated or deactivated, and (b) second alerts that notify the user that no capacity currently exists for further activation of instances of the UMB adapters.

In other specific embodiments of the system, the first ML includes a multiclass classifier ML algorithm configured to map first data tags in the first message format to second data tags in the universal message format. In related embodiments of the system, the second ML includes auto regressive ML model(s) configured to convert the first data tags in the message from the first message format to the second data tags in the universal message format.

In further specific embodiments of the system, the UMB adapter is built on a computing language, such as PYTHON® of the Python Software Foundation, which does not require compilation of source code. As such the UMB adapter is platform independent.

A computer-implemented method for universal message brokering defines second embodiments of the invention. The computer-implemented method is executed by one or more computing processor devices. The method includes receiving, at a first Universal Message Broker (UMB) adapter deployed in a first computing platform, a message, in a first message format, from the first computing platform. In response to receiving the message, the method further includes implementing, at the first UMB adapter, first Artificial Intelligence (AI) including first Machine Learning (ML) to analyze the message to identify (i) the first computing platform and (ii) a second computing platform to which the message is to be broadcasted and implementing, at the first UMB adapter, second AI including second ML to convert the message from the first message format to a universal message format. Once the message has been converted/transformed to the universal message format, the method includes broadcasting the message in the universal message format to the second computing platform. In response to broadcasting of the message, the method includes receiving, at a second UMB adapter deployed in the second computing platform, the message in the universal message format, and implementing, at the second UMB adapter, second AI including second ML to convert the message from the universal message format to a second message format applied by the second computing platform.

In specific embodiments the computer-implemented method further includes identifying the universal message format by at least one of (i) implementing the second AI including the second ML to identity the universal message format, and (ii) receiving, at a dashboard application, one or more first user inputs that identify the universal message format.

In further specific embodiments the computer-implemented method includes implementing, at the first UMB adapter and/or the second UMB adapter, third AI including third ML to analyze current message traffic received by the UMB adapter and predict future message traffic at the UMB adapter. In related embodiments the computer-implemented method further includes, in response to predicting the future message traffic at the UMB adapter, performing at least one of (i) adjusting a size of a message queue and (ii) activating or deactivating instances of the UMB adapters.

A computer program product including a non-transitory computer-readable medium defines third embodiments of the invention. The computer-readable medium includes sets of codes for causing computing device(s) to receive, at a first Universal Message Broker (UMB) adapter deployed in a first computing platform, a message in a first message format from the first computing platform, In response to receiving the message, the sets of codes further cause the computing device(s) to implement, at the first UMB adapter, (a) first Artificial Intelligence (AI) including first Machine Learning (ML) to analyze the message to identify (i) the first computing platform and (ii) a second computing platform to which the message is to be broadcasted, and (b) second AI including second ML to convert the message from the first message format to a universal message format. In addition, the sets of codes further cause the computing device(s) to broadcast the message in the universal message format to the second computing platform. In response to broadcasting the message, the sets of codes further cause the computing device(s) to receive, at a second UMB adapter deployed in the second computing platform the message in the universal message format and implement, at the second UMB adapter, the second AI including the second ML to convert the message from the universal message format to a second message format applied by the second computing platform.

In specific embodiments of the computer program product, the sets of codes further include a set of codes for causing the one or more computing devices to identify the universal message format by at least one of (i) implementing the second AI including the second

ML to identity the universal message format and (ii) receiving, at a dashboard application, one or more first user inputs that identify the universal message format.

In other specific embodiments of the computer program product, the sets of codes further include a set of codes for causing the one or more computing devices to implement, at first UMB adapter and/or the second UMB adapter, third AI including third ML to analyze current message traffic received by the UMB adapter and predict future message traffic at the UMB adapter. In related embodiments of the computer program product, the sets of codes further include a set of codes for causing the one or more computing devices to, in response to predicting the future message traffic at the UMB adapter, perform at least one of (i) adjusting a size of a message queue and (ii) activating or deactivating instances of the UMB adapters.

Thus, according to embodiments of the invention, which will be discussed in greater detail below, the present invention provides for universal message brokering across all known and future known computing platforms/systems. Specifically, message brokering occurs within adapters, so-called Universal Message Broker (UMB) adapters that are deployed directly within the computing platforms/systems. The UMB adapters rely on Artificial Intelligence (AI) including Machine Learning (ML) to (i) identify the source (i.e., the platform/system that the adapter is deployed within) and the target computing platforms/systems (i.e., the platform/system where the message is designated for receipt) and (ii) convert/translate the messages from the first message format of the source computing platform/system to an identified universal message format and from the universal message format to the second message format used by the target computing platform/system. In specific embodiments of the invention, the UMB adapters implement AI including ML to predict the volume of further message traffic and, in response, adjust message queues and/or UMB adapter activation in servers or the like.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for adapter-based universal message brokering, in accordance with embodiments of the present invention;

FIG. 2 is a block diagram of a computing platform/system including a Universal Message Broker (UMB) adapter, in accordance with embodiments of the present invention;

FIG. 3 is a block diagram of the computer platform/system including a dashboard application, in accordance with embodiments of the present invention;

FIG. 4 is a schematic/block diagram of a system for adapter-based universal message brokering highlighting various exemplary computing platforms/systems, in accordance with embodiments of the present invention; and

FIG. 5 is a flow diagram of a method for adapter-based universal message brokering, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that provide for universal message brokering across all known and future known computing platforms/systems. Specifically, message brokering occurs within adapters, so-called Universal Message Broker (UMB) adapters that are deployed directly within the computing platforms/systems, thus, eliminating the need for any special infrastructure/hardware to exist between disparate computing platforms/systems.

The adapters are configured to receive messages emanating from the computing platform/system that they are deployed within and implement Artificial Intelligence (AI) including Machine Learning (ML) to (i) identify the source (i.e., the platform/system that the adapter is deployed within) and the target computing platforms/systems (i.e., the platform/system where the message is designated for receipt) and (ii) convert/translate the messages from the first message format of the source computing platform/system to an identified universal message format. In specific embodiments of the invention, multiclass classifier ML algorithms that rely on data mapping are used to identify the source and target computing platforms/systems and auto regressive ML models are used to convert/translate the message format to/from the universal message format. In other specific embodiments, the universal message format that is implemented for a specific message brokering process may be identified/determined by AI including ML or may be identified/defined by a user.

Once converted/translated to the universal message format, the UMB adapter broadcasts the message to the target computing system, which has a UMB adapter deployed therein. The UMB adapter of the target computing system is configured to receive the message and implement corresponding AI including ML to convert/translate the universal message format to the first message format implemented in the target computing system.

In specific embodiments of the invention, the UMB adapters are further configured to implement AI including ML to predict the volume of future message traffic. In response to such predictions, the UMB adapters are configured to adjust (increase or decrease) (i) the messaging queue in monolithic computing platforms/systems or (ii) the activation of adapters installed in servers of distributed computing platforms/systems.

In further embodiments of the invention, a dashboard application is implemented that allows user to define the universal message format, tuning new or existing ML models, receive alerts when UMB adapters are activated within servers and/or no further server capacity is available for UMB adapter activation.

As such, the present invention provides for universal messaging brokering across all computing platforms/systems. Further, by using adapters that deployed directly within the computing systems, the present invention eliminates the need for additional architecture/hardware to be implemented between the disparate computing platforms/system.

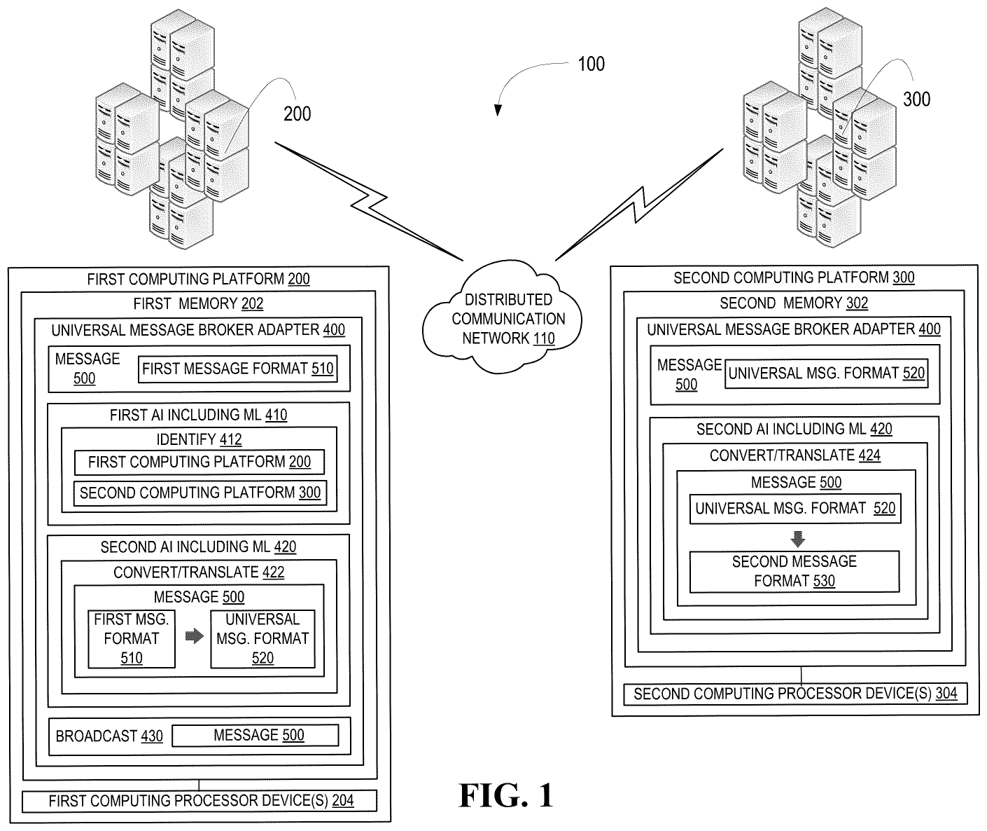

Referring to FIG. 1, a schematic/block diagram is presented of a system 100 for universal message brokering, in accordance with embodiments of the invention. The system 100 may be implemented in conjunction with one or more distributed communication networks 110, such as the Internet, intranet(s), cellular network(s) and the like. System 100 includes a first computing platform 200 and a second computing platform 300. In accordance with embodiments of the invention first computing platform 200 and second computing platform 300 are disparate computing platforms that use different messaging formats and/or protocols. First and second computing platforms 200, 300 may comprise one (e.g., a monolithic platform/system) or multiple computing devices (e.g., a distributed platform/system), such as multiple servers (as shown in FIG. 1) or the like.

The first and second computing platforms 200, 300 include memory 202, 302 and one, or typically more, computing processor devices 204, 304 in communication with the corresponding memory 202, 302. One of ordinary skill in the art will appreciate that in distributed computing platforms, memory 202 and/or 302 and computing processor devices 204 and/or 304 may be disposed within multiple different computing devices/apparatus, which comprise first and/or second computing platform 200, 300.

Memory 202, 302 of first and second computing platforms 200, 300 includes Universal Message Broker (UMB) adapter 400 that is executable by at least one of the computing processor devices 204, 304. The term “adapter” as used herein refers to a software design pattern that allows the interface of an existing class to be used as another interface. The adapter acts as a bridge between two incompatible computing platforms/systems, enabling them to accomplish functions in unison. The adapter pattern is beneficial when the client code expects a certain interface, but the class that is being called upon implements a different interface or, in this instance, different messaging interfaces.

In the illustrated embodiment of FIG. 1, first computing platform 200 is attempting to communicate a message 500 to second computing platform 300. Thus, as described, UMB adapter 400 is configured to perform specific functions at the first computing platform 200 (i.e., at the message sending computing platform/system) and separate functions at the second computing platform 300 (i.e., at the message receiving computing platform/system). However, one of ordinary skill in the art will appreciate that in other instances second computing platform 300 may be attempting to communicate a message 500 to first computing platform 300. Thus, in such embodiments of the invention, the specific functions performed by UMB adapter 400 will be reversed.

At first computing platform 200, UMB adapter 400 is configured to receive a message 500, which is emanating from first computing platform 200 or some other computing platform and is in a first message format 510. Message format as used herein refers to the structure and organization of data and defines how information is encoded and arranged within the message. Data structure refers to the arrangement of data fields within the message, including the order of the fields, the data types specific to each field and any rules or constraints on the data.

In response to receiving message 500, UMB adapter 400 is configured to implement first Artificial Intelligence (AI) including Machine Learning (ML) techniques 410 to analyze the message and identity 412 both the message originating computing platform (i.e., first computing platform 200 or another computing platform) and the message receiving computing platform (i.e., second computing platform 300). Further, UMB adapter 400 is configured to implement second AI including second ML techniques 420 to convert 422, otherwise referred to and translate or transform, the message 500 from the first message format 510 to a universal message format 520. In response to converting/translate 422 the message 500, UMB adapter 400 is configured to broadcast the message 500, in the universal message format 520, to the second computing platform 300.

At second computing platform 300, UMB adapter 400 is configured to receive the message 500 in the universal message format 520 and implement the second AI including second ML techniques 420 to convert/translate 424 the message 500 from the universal message format 520 to a second message format 530 that is used or otherwise applied, at the second computing platform 300.

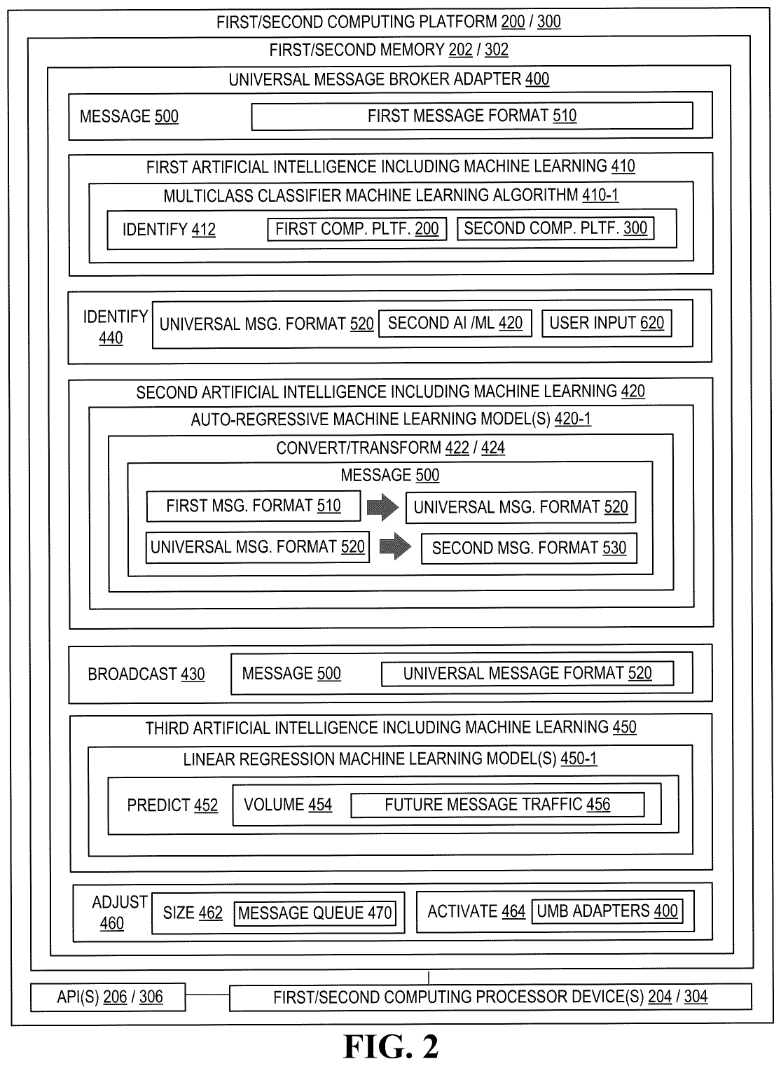

Referring to FIG. 2, a block diagram is presented of the first and second computing platforms 200, 300 highlighting various alternative functions of the UMB adapter 400, in accordance with embodiments of the present invention. As previously discussed in relation to FIG. 1, first and second computing platforms 200, 300 may comprise one or multiple computing devices, such as servers, or the like. Moreover, first and second computing platforms 200, 300 include memory 202, 302, which may comprise volatile and/or non-volatile memory, such as read-only memory (ROM) and/or random-access memory (RAM), EPROM, EEPROM, flash cards, or any memory common to computing platforms. Moreover, memory 202, 302 may comprise cloud storage, such as provided by a cloud storage service and/or a cloud connection service.

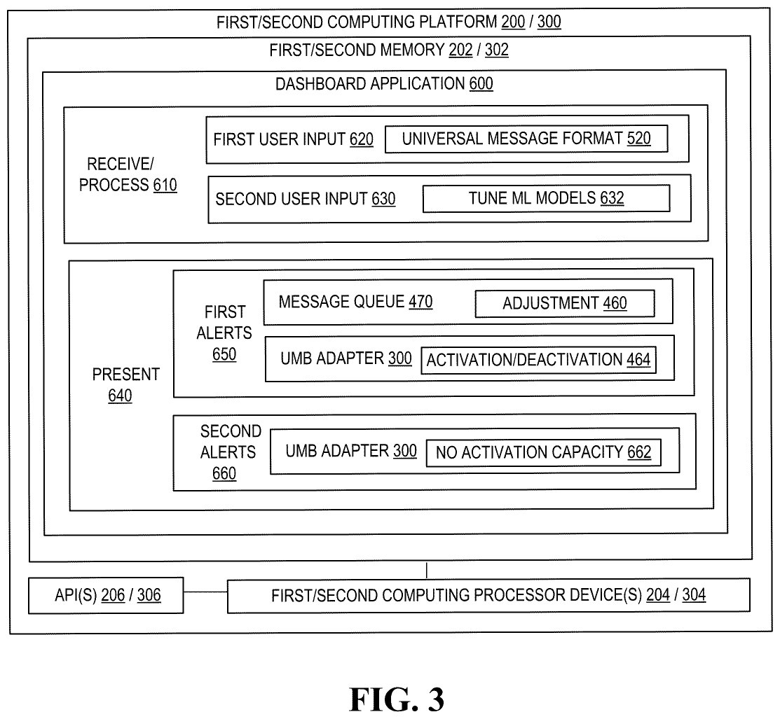

Further, first and second computing platforms 200, 300 include one or more computing processor devices 204, 304, which may be an application-specific integrated circuit (“ASIC”), or other chipset, logic circuit, or other data processing device. Computing processor device(s) 204, 304 may execute one or more application programming interface (APIs) 206, 306 that interface with any resident programs, such as UMB adapter 400 or dashboard application 600 (shown FIG. 3) and the like, stored in memory 202, 302 of first and second computing platforms 200, 300 and any external programs. First and second computing platforms 200, 300 may include various processing sub-systems (not shown in FIGS. 2 and 3) embodied in hardware, firmware, software, and combinations thereof, that enable the functionality of first and second computing platforms 200, 300 and the operability of first and second computing platforms 200, 300 on a distributed communication network 110 (shown in FIG. 1), such as the Internet, intranet(s), cellular network(s) and the like. For example, processing sub-systems allow for initiating and maintaining communications and exchanging data with other networked devices. For the disclosed aspects, processing sub-systems of computing platform 200 may include any sub-system used in conjunction with UMB adapter 400, dashboard application 600 and related tools, routines, sub-routines, applications, sub-applications, sub-modules thereof.

In specific embodiments of the present invention, first and second computing platforms 200, 300 additionally include a communications module (not shown in FIGS. 2 and 3) embodied in hardware, firmware, software, and combinations thereof, that enables electronic communications between components of first and second computing platforms 200, 300 and other networks and network devices. Thus, communication module may include the requisite hardware, firmware, software and/or combinations thereof for establishing and maintaining a network communication connection with one or more devices and/or networks.

Memory 202, 302 of first and second computing platforms 200, 300 stores UMB adapter 400, which is built on computing language that does not require compilation of source code (e.g., PYTHON® of the Python Software Foundation), as such, the UMB adapter 400 of the present invention is computing platform independent (i.e., can readily be deployed in any known or future known computing platform/system). As previously discussed in relation to FIG. 1, UMB adapter 400 is configured to a receive message 500 in first message format 510 and implement first AI including first ML techniques 410 to identify 412 analyze the message and identity 412 both the message originating computing platform (i.e., first computing platform 200 or another computing platform) and the message receiving computing platform (i.e., second computing platform 300). In specific embodiments of the invention, first AI including first ML techniques 410 is a multiclass classifier ML algorithm 410-1.

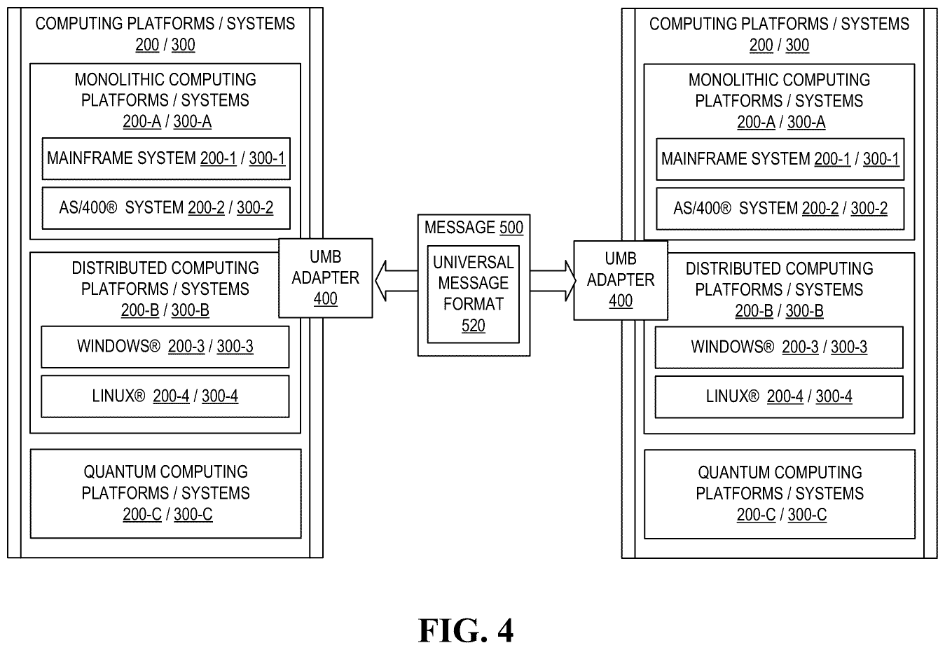

In specific embodiments of the invention, UMB adapter 400 is further configured to identify 440 the universal message format 520 that is to be implemented in the conversion/translation process. The universal message format may be extended Mark-up Language (XML), JavaScript Object Notation (JSON) or the like. In specific embodiments of the invention, second AI including second ML 420, such as ML models are trained to identify/determine the most appropriate universal message format 520 based, at least, on the previously identified message sending and message receiving computing platforms/systems. While in other specific embodiments of the invention, a user, with knowledge of the identified message sending and message receiving computing platforms/systems may provide user input(s) 620 that serve to define/select the universal message format 520. As discussed infra., in relation to FIG. 4, such user inputs 620 may be provided via dashboard application 600.

UMB adapter 400 is further configured to implement second AI including second ML 420 to convert/translate 422 the message 500 from the first message format 510 to the universal message format 520 and, upon receipt by the message-receiving computing platform, convert/translate 424 the message 500 from the universal message format 520 to the second message format 530. In specific embodiments of the invention, second AI including second ML is auto-regressive machine learning (ML) model(s) 420-1 that are configured to perform data mapping that maps tags in the first message format 510 to tags in the universal message format 520 or maps tags in the universal message format 520 to tags in the second message format 530 for purposes of conversion/translation 422, 424. Once converted/translated 422 from the first message format 510 to the universal message format 520, UMB adapter is configured to initiate the process by which message 500 is broadcasted 430 to the message-receiving computing

In further specific embodiments of the invention, UMB adapter 400 is further configured to implement third AI including third ML 450 to predict 452 a volume 454 of future message traffic 456 communicated by and/or received computing platform/system on which the UMB adapter 400 is deployed. In specific embodiments of the invention, third AI including ML comprises linear regression ML model(s) that are configured to analyze current and past message traffic to predict 452 the volume 454 of further message traffic 456. In response to predicting 452 the volume 454 of future message traffic 456, UMB adapter 400 is further configured to, when the predicted future message traffic warrants such, adjust 460 (i.e., increase or decrease) the size 462 of a message queue 470 in monolithic computing platforms/systems or activate 464 (or in some instances deactivate) further UMB adapters 400 deployed in servers of distributed computing platforms/systems. For example, if the predicted future message traffic 456 exceeds a predetermined threshold, the message queue 470 may be increased in size 462 of additional UMB adapters 400 may be activated 464 in servers within a designated server cluster or the like.

Referring to FIG. 3 a block diagram is presented of first and second computing platforms 200, 300 including a dashboard application 600, in accordance with embodiments of the present invention. The dashboard application 600, which is stored in memory 202, 302 and executable by at least one of the corresponding first and second computing processor devices 204, 304, is configured to receive 610 and process first user inputs 620 that define the universal message format 520. In such embodiments of the invention, the dashboard application 600 may notify the user of the message-sending computing platform and the message-receiving computing platform and the user may rely on such data in selecting the universal message format 520. In other embodiments of the invention, dashboard application may be configured to receive 610 and process second user inputs 630 that serve to tune ML models included in first AI and first ML 410, second AI and second ML 420 and/or third Ai and third ML 450.

In additional specific embodiments of the invention, dashboard application 600 is configured to present 640 first alerts 650 that notify the user of adjustments 460 (increases or decreases) to the message queue 470 and/or activation/deactivation 464 of UMB adapters 400 in servers or the like. Moreover, in further specific embodiments of the invention, dashboard application 600 is configured to present 640 second alerts 660 that notify the user that no activation capacity 662 currently exists for UMB adapter 300 activation. Second alert 660 occurs in response to predicting 452 an increase in future message traffic 456 that warrants activation 464 of additional UMB adapters 300 in servers or the like.

Referring to FIG. 4 a schematic/block diagram is presented of a system 100 for adapter-based universal message brokering highlighting various exemplary computing platforms/systems, in accordance with embodiments of the present invention. Computing platforms 200, 300 include monolithic computing platforms/systems 200-A, 300-A such as mainframe computing systems 200-1, 300-1, Application Systems/400 (AS/400®) developed by International Business Systems (IBM) of Armonk, New York. In addition, computing platforms 200, 300 include distributed computing platforms/systems 200-B, 300-B such as WINDOWS® computing platform/system 200-3, 300-3 developed by Microsoft Corporation of Redmond, Washington and LINUX® developed by the Linux Foundation of San Francisco, California. Additionally, computing platforms 200, 300 may include quantum computing platforms/systems 200-C, 300-C or other future known computing platforms/systems. Each computing platform 200, 300 will have at least one UMB adapter 400 deployed and activated that is configured to translate/convert messages 500 to a universal message format 520 and broadcast the translated/converted message 500 to a designated message-receiving computing platform/system.

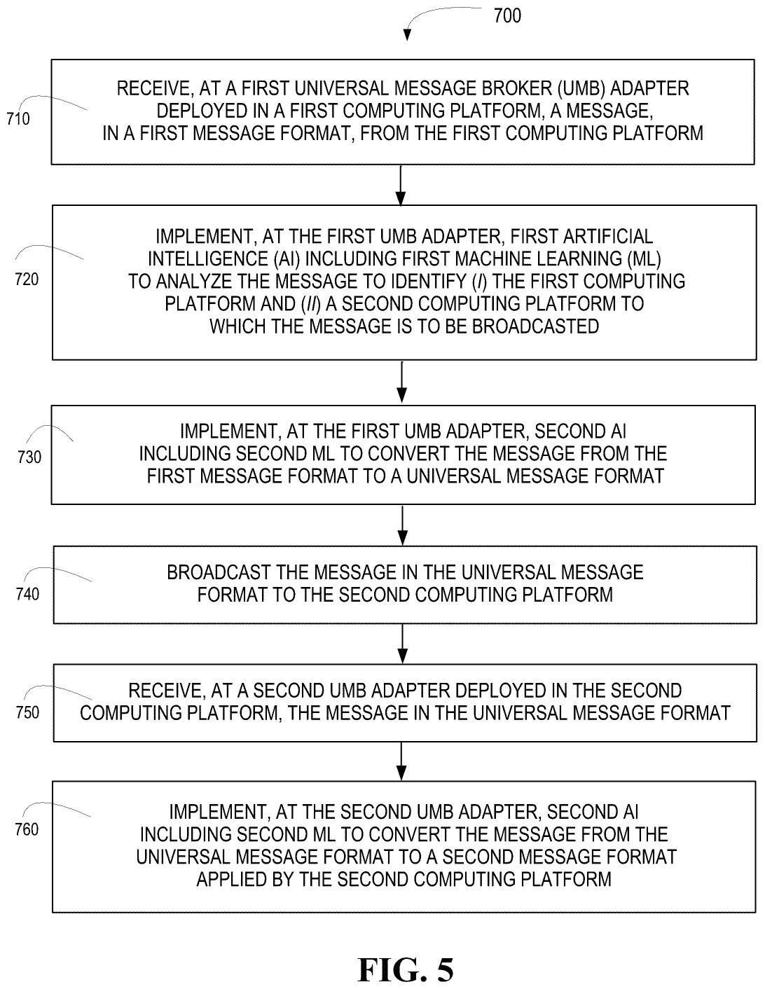

Referring to FIG. 5, a flow diagram is depicted of a method 800 for adapter-based universal message brokering, in accordance with embodiments of the present invention. At Event 810, a message having a first message format is received at a UMB adapter deployed with a first computing platform/system. The UMB adapter may deployed within a controlled node/server of a computing platform or the like.

At Event 720, first AI including ML is implemented at the UMB adapter to analyze the message and identify the message-sending computing platform (e.g., first computing platform) and the message-receiving computing platform (e.g., second computing platform). In response to identifying the computing platforms, at Event 730, second AI including ML at the UMB adapter to convert/translate the message from the first message format to a universal message format (e.g., XML, JSON or the like). In specific embodiments of the method, ML models within the second AI and ML are trained to identify the universal message format based on, at least, the identified computing platforms. While in other embodiments of the method, the universal message format may be selected by a user.

In response to converting/translating the message, at Event 740, the message, in the universal message format, is broadcasted to the message-receiving computing platform/system (i.e., second computing platform or the like) and, at Event 750, the message-receiving computing platform/system (i.e., second computing platform or the like) receives the message in the universal message format.

In response to receiving the message, the UMB adapter at the message-receiving computing platform/system implements the second AI including ML to convert/translate the message from the universal message format to the second message format used/applied by the message-receiving computing platform/system.

In additional embodiments of the method, the UMB adapter at either the message sending or message-receiving computing platforms/systems implements third AI including ML to predict the volume of future message traffic and, in response, if the predicted message traffic warrants such, adjust the message queue (in monolithic computing platforms/systems) or UMB adapter activation (in distributed computing platforms/systems).

Thus, present embodiments of the invention discussed in detail above, the present invention provides for universal message brokering across all known and future known computing platforms/systems. Specifically, message brokering occurs within adapters, so-called Universal Message Broker (UMB) adapters that are deployed directly within the computing platforms/systems. The UMB adapters rely on Artificial Intelligence (AI) including Machine Learning (ML) to (i) identify the source (i.e., the platform/system that the adapter is deployed within) and the target computing platforms/systems (i.e., the platform/system where the message is designated for receipt) and (ii) convert/translate the messages from the first message format of the source computing platform/system to an identified universal message format and from the universal message format to the second message format used by the target computing platform/system. In specific embodiments of the invention, the UMB adapters implement AI including ML to predict the volume of further message traffic and, in response, adjust message queues and/or UMB adapter activation in servers or the like.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for universal message brokering, the system comprising:
a first computing platform including a first memory and one or more first computing processor devices in communication with the memory, wherein the first memory stores at least one first instance of a Universal Message Broker (UMB) adapter, executable by at least one of the one or first computing processor devices, wherein the at least one first instance of the UMB adapter is configured to, upon activation:
receive a message from the first computing platform, wherein the message is received in a first message format,
implement first Artificial Intelligence (AI) including first Machine Learning (ML) to analyze the message to identify (i) the first computing platform and (ii) a second computing platform to which the message is to be broadcasted,
implement second AI including second ML to convert the message from the first message format to a universal message format, and
broadcast the message in the universal message format to the second computing platform;
a second computing platform including a second memory and one or more second computing processor devices in communication with the memory, wherein the second memory stores at least one second instance of the UMB adapter, executable by at least one of the one or more second computing processor devices, wherein the least one second instance of the UMB adapter is configured to, upon activation:
receive the message in the universal message format, and
implement the second AI including the second ML to convert the message from the universal message format to a second message format applied by the second computing platform.

2. The system of claim 1, wherein the at least one first instance of the UMB adapter is configured to, upon activation:
identify the universal message format based, at least, on compatibility with the first and second computing platforms.

3. The system of claim 2, wherein the at least one first instance of the UMB adapter is configured to, upon activation:
implement the second AI including the second ML to identity the universal message format.

4. The system of claim 3, wherein the first memory and the second memory further store a dashboard application executable by at least one of the one or more first computing processor devices and second computing processor devices, wherein the dashboard application is configured to:
receive one or more first user inputs that identify the universal message format.

5. The system of claim 4, wherein the dashboard application is further configured to:
receive one or more second user inputs that are configured to tune one or more ML models from amongst at least one of the first ML and the second ML.

6. The system of claim 1, wherein the UMB adapter is further configured to, upon activation:
implement third AI including third ML to analyze current message traffic received by the UMB adapter and predict future message traffic at the UMB adapter.

7. The system of claim 6, wherein the UMB adapter is further configured to, upon activation, implement the third AI including the third ML, wherein the third ML comprises one or more linear regression models.

8. The system of claim 6, wherein the UMB is further configured to, upon activation:
in response to predicting the future message traffic at the UMB adapter, perform at least one of (i) adjusting a size of a message queue and (ii) activating or deactivating instances of the UMB adapters.

9. The system of claim 8, wherein the first memory and the second memory further store a dashboard application executable by at least one of the one or more first computing processor devices and second computing processor devices, wherein the dashboard application is configured to:
present at least one of (a) first alerts that notify the user of at least one of (i) adjustment to the size of the message queue, and (ii) specific instances of the UMB adapters that have been activated or deactivated, and (b) second alerts that notify the user that no capacity currently exists for further activation of instances of the UMB adapters.

10. The system of claim 1, wherein the at least one first instance of the UMB adapter is configured to, upon activation, implement the first Artificial Intelligence (AI) including the first Machine Learning (ML), wherein the first ML includes a multiclass classifier ML algorithm configured to map first data tags in the first message format to second data tags in the universal message format.

11. The system of claim 10, wherein the at least one first instance of the UMB adapter is configured to, upon activation, implement the second Artificial Intelligence (AI) including the second Machine Learning (ML), wherein the second ML includes one or more auto regressive ML models configured to convert the first data tags in the message from the first message format to the second data tags in the universal message format.

12. The system of claim 10, wherein the UMB adapter is built on a computing language that does not require compilation of source code.

13. A computer-implemented method for universal message brokering, the computer-implemented method executed by one or more computing processor devices and comprising:
receiving, at a first Universal Message Broker (UMB) adapter deployed in a first computing platform, a message from the first computing platform, wherein the message is received in a first message format;
implementing, at the first UMB adapter, first Artificial Intelligence (AI) including first Machine Learning (ML) to analyze the message to identify (i) the first computing platform and (ii) a second computing platform to which the message is to be broadcasted;
implementing, at the first UMB adapter, second AI including second ML to convert the message from the first message format to a universal message format;
broadcasting the message in the universal message format to the second computing platform;
receiving, at a second UMB adapter deployed in the second computing platform, the message in the universal message format; and
implementing, at the second UMB adapter, second AI including second ML to convert the message from the universal message format to a second message format applied by the second computing platform.

14. The computer-implemented method of claim 13, further comprising:
identifying the universal message format by at least one of (i) implementing the second AI including the second ML to identity the universal message format and (ii) receiving, at a dashboard application, one or more first user inputs that identify the universal message format.

15. The computer-implemented method of claim 13, further comprising:
implementing, at, at least one of, the first UMB adapter and the second UMB adapter, third AI including third ML to analyze current message traffic received by the UMB adapter and predict future message traffic at the UMB adapter.

16. The computer-implemented method of claim 15, further comprising:
in response to predicting the future message traffic at the UMB adapter, performing at least one of (i) adjusting a size of a message queue and (ii) activating or deactivating instances of the UMB adapters.

17. A computer program product comprising:
a non-transitory computer-readable medium comprising sets of codes for causing one or more computing devices to:
receive, at a first Universal Message Broker (UMB) adapter deployed in a first computing platform, a message from the first computing platform, wherein the message is received in a first message format;
implement, at the first UMB adapter, first Artificial Intelligence (AI) including first Machine Learning (ML) to analyze the message to identify (i) the first computing platform and (ii) a second computing platform to which the message is to be broadcasted;
implement, at the first UMB adapter, second AI including second ML to convert the message from the first message format to a universal message format;
broadcast the message in the universal message format to the second computing platform;
receive, at a second UMB adapter deployed in the second computing platform the message in the universal message format; and
implement, at the second UMB adapter, the second AI including the second ML to convert the message from the universal message format to a second message format applied by the second computing platform.

18. The computer program product of claim 17, wherein the sets of codes further include a set of codes for causing the one or more computing devices to:
identify the universal message format by at least one of (i) implementing the second AI including the second ML to identity the universal message format and (ii) receiving, at a dashboard application, one or more first user inputs that identify the universal message format.

19. The computer program product of claim 17, wherein the sets of codes further include a set of codes for causing the one or more computing devices to:
implement, at, at least one of, the first UMB adapter and the second UMB adapter, third AI including third ML to analyze current message traffic received by the UMB adapter and predict future message traffic at the UMB adapter.

20. The computer program product of claim 19, wherein the sets of codes further include a set of codes for causing the one or more computing devices to:
in response to predicting the future message traffic at the UMB adapter, perform at least one of (i) adjusting a size of a message queue and (ii) activating or deactivating instances of the UMB adapters.
